(19) United States
(12) Patent Application Publication
(10) Pub. No.: US 2026/0073501 A1
(43) Pub. Date: Mar. 12, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: TAKAYUKI JINNO, Kanagawa (JP)

(21) Appl. No.: 19/319,490

(22) Filed: Sep. 4, 2025

(30) Foreign Application Priority Data
Sep. 11, 2024 (JP) 2024-157661

(51) Int. Cl. G06T 7/00; G06T 7/50; G06T 7/90

(52) U.S. Cl. CPC G06T 7/0004; G06T 7/50; G06T 7/90; G06T 2207/10152

(57) ABSTRACT

An image processing apparatus comprises at least one processor and at least one memory. The at least one memory stores instructions for causing the at least one processor and the at least one memory to set a light source to be turned on from among a plurality of light sources disposed at positions different from each other, based on a gloss reflection intensity of an object to be inspected, and perform inspection processing on the object, based on a plurality of images of the object. In the plurality of images of the object, the object is irradiated with light from the set light source.

### BACKGROUND

### Field of the Technology

The present disclosure relates to an image processing technology for inspecting an object.

### Description of the Related Art

As an industrial product appearance inspection technology, a technology for detecting irregularities of an inspection surface is known. An example of methods to be used to detect irregularities may be a photometric stereo technology that estimates an inclination and/or a reflectance at each position on an inspection surface based on a plurality of images acquired by image capturing an object irradiated with light from a plurality of directions. Japanese Patent Laid-Open No. 2018-105870 describes a technology in which lighting patterns of a plurality of light sources are stored in advance in a lighting apparatus for photometric stereo, and a lighting pattern is retrieved based on a control signal and applied.

When an object surface inspection is performed based on captured images, some gloss characteristics of an object surface may cause a reflection of a light source on an inspection surface, which may degrade accuracy of the inspection.

### SUMMARY

Embodiments of the present disclosure are directed to an improvement in inspection accuracy of an object surface based on captured images.

According to an aspect of the present disclosure, an image processing apparatus includes at least one processor and at least one memory that is in communication with the at least one processor. The at least one memory stores instructions for causing the at least one processor and the at least one memory to set a light source to be turned on from among a plurality of light sources disposed at positions different from each other, based on a gloss reflection intensity of an object to be inspected, and perform inspection processing on the object, based on a plurality of images of the object. In the plurality of images of the object, the object is irradiated with light from the set light source.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating image capturing of an object surface.

FIG. 2A is a diagram illustrating an example of a hardware configuration of an appearance inspection system. FIG. 2B is an entire external front view of the appearance inspection system. FIG. 2C is an entire external top view of the appearance inspection system.

FIG. 3 is a diagram illustrating an example of a functional configuration of the appearance inspection system.

FIG. 4A is a front view of a lighting apparatus. FIG. 4B is a top view of the lighting apparatus.

FIG. 5 is a flowchart illustrating processing in an image processing system.

FIG. 6 is a flowchart illustrating processing for setting a lighting pattern of a light source.

FIG. 7 is a diagram illustrating an example of a user interface.

FIG. 8 is a diagram illustrating an example of a list file in which a correspondence relationship between an inspection target object, gloss information, and a light source ID is described.

### DESCRIPTION OF THE EMBODIMENTS

Hereinafter, embodiments will be described with reference to the drawings. Not all combinations of features described in each embodiment are necessarily essential to the solutions of the present disclosure.

### First Embodiment

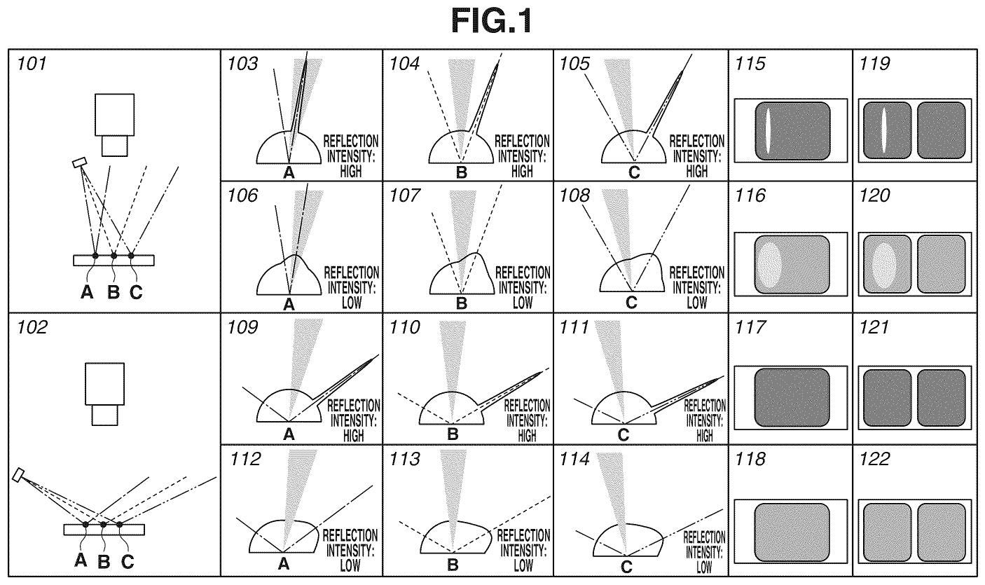

There is a technology for inspecting an object surface based on captured images acquired by image capturing an object irradiated with light from a plurality of different directions. In this inspection, depending on gloss characteristics of the object surface, accuracy of deriving shape information on and a reflectance of the object surface may be reduced due to an influence of a light source reflected on the inspection surface. FIG. 1 is a diagram illustrating image capturing of two object surfaces each having a different gloss reflection intensity (reflected image clarity), which is one element of the gloss characteristics. In a geometric condition 101, an object irradiated with light from a position with a relatively small zenith angle is captured, and in a geometric condition 102, an object irradiated with light from a position with a relatively large zenith angle is captured.

In the geometric condition 101, a relationship 103 indicates a relationship between a reflection characteristic and a light receiving angle range in a case where an image of a position A of an object having a high gloss reflection intensity is captured. A relationship 104 indicates a relationship between a reflection characteristic and a light receiving angle range in a case where an image of a position B of the object having a high gloss reflection intensity is captured. A relationship 105 indicates a relationship between a reflection characteristic and a light receiving angle range in a case where an image of a position C of the object having a high gloss reflection intensity is captured. Here, the reflection characteristics are represented by a generally known bidirectional reflectance distribution function (BRDF). At each of the positions B and C, a strong reflection component (surface reflection component) in a vicinity of specular reflection is not included in the light receiving angle range, whereas at the position A, the surface reflection component is included in the light receiving angle range. An image 115 is acquired by capturing an image of the object surface having a high gloss reflection intensity under the geometric condition 101. It can be observed that an influence of the gloss characteristics is significant in a part of the object surface in the image 115. An image 119 is acquired by collectively capturing two objects having a high gloss reflection intensity under the geometric condition 101. It is observed in the image 119 that any one of the objects is significantly affected by the gloss characteristics when there is a plurality of objects.

In the geometric condition 101, a relationship 106 indicates a relationship between a reflection characteristic and a light receiving angle range in a case where the position A of an object having a low gloss reflection intensity is captured. A relationship 107 indicates a relationship between a reflection characteristic and a light receiving angle range in a case where an image of the position B of the object having a low gloss reflection intensity is captured. A relationship 108 indicates a relationship between a reflection characteristic and a light receiving angle range in a case where an image of the position C of the object having a low gloss reflection intensity is captured. In a case of the object surface having a low gloss reflection intensity, a surface reflection component is included in the light receiving angle range at each of the position A, the position B, and the position C. However, on the object surface having a low gloss reflection intensity, the surface reflection component is dispersed over a wide angle, and strong reflection does not occur at a specific angle, and thus the variation in the amounts of received light of the surface reflection component across different positions is small. An image 116 is acquired by capturing an image of the object surface having a low gloss reflection intensity under the geometric condition 101. In the image 116, an influence of the gloss characteristics slightly occurs on a part of the object surface, but it is observed that the influence is small. An image 120 is acquired by collectively capturing two objects having a low gloss reflection intensity under the geometric condition 101. In the image 120, it can be observed that any of the objects is slightly affected by the gloss characteristics when there is a plurality of objects, but the effect is small.

In the geometric condition 102, a relationship 109 indicates a relationship between a reflection characteristic and a light receiving angle range in a case where an image of the position A of an object having a high gloss reflection intensity is captured. A relationship 110 indicates a relationship between a reflection characteristic and a light receiving angle range in a case where an image of the position B of the object having a high gloss reflection intensity is captured. A relationship 111 indicates a relationship between a reflection characteristic and a light receiving angle range in a case where an image of a position C of the object having a high gloss reflection intensity is captured. A surface reflection component is not included in the light receiving angle range at any of the position A, the position B, and the position C. An image 117 is acquired by capturing an image of the object surface having a high gloss reflection intensity under the geometric condition 102. It can be observed from the image 117 that the object surface is not affected by the gloss characteristics. An image 121 is acquired by collectively capturing two objects having a high gloss reflection intensity under the geometric condition 102. In the image 121, it can be observed that the object surfaces are not affected by the gloss characteristics even when there is a plurality of objects.

In the geometric condition 102, a relationship 112 indicates a relationship between a reflection characteristic and a light receiving angle range in a case where an image of the position A of an object having a low gloss reflection intensity is captured. A relationship 113 indicates a relationship between a reflection characteristic and a light receiving angle range in a case where an image of the position B of the object having a low gloss reflection intensity is captured. A relationship 114 indicates a relationship between a reflection characteristic and a light receiving angle range in a case where an image of the position C of the object having a low gloss reflection intensity is captured. A surface reflection component is not included in the light receiving angle range at any of the position A, the position B, and the position C. An image 118 is acquired by capturing an image of the object surface having a low gloss reflection intensity under the geometric condition 102. It can be observed that the image 118 does not include an influence of the gloss characteristics on the object surface. An image 122 is acquired by collectively capturing two objects having a low gloss reflection intensity under the geometric condition 102. It can be observed from the image 122 that the object surfaces are not affected by the gloss characteristics even when there is a plurality of objects. That is, under the geometric condition in which a zenith angle is relatively large, a captured image is less likely affected by an influence of the gloss characteristics.

In a photometric stereo method, it is known that accuracy of deriving shape information on and a reflectance of an object surface is increased by using images acquired by image capturing under a condition that a plurality of light sources is disposed in a range as wide as possible in both a zenith angle and an azimuth angle. In a case of an object having a high gloss reflection intensity, if a light source having a small zenith angle is used, an influence of the surface reflection component is significant, and accuracy of deriving shape information on and a reflectance of the object surface is reduced. Thus, in the present embodiment, a lighting pattern of light sources for use in image capturing is switched according to a gloss reflection intensity of an object. Specifically, with respect to an object having a high gloss reflection intensity, a light source having a relatively large zenith angle is turned on to cause an image to be less affected by a surface reflection component. On the other hand, with respect to an object having a low gloss reflection intensity, both a light source having a small zenith angle and a light source having a large zenith angle are turned on to increase accuracy of deriving shape information on and reflectance of the object surface. With this configuration, accuracy of an inspection of an object surface based on captured images is improved.

### <Appearance and Hardware Configuration of Appearance Inspection System>

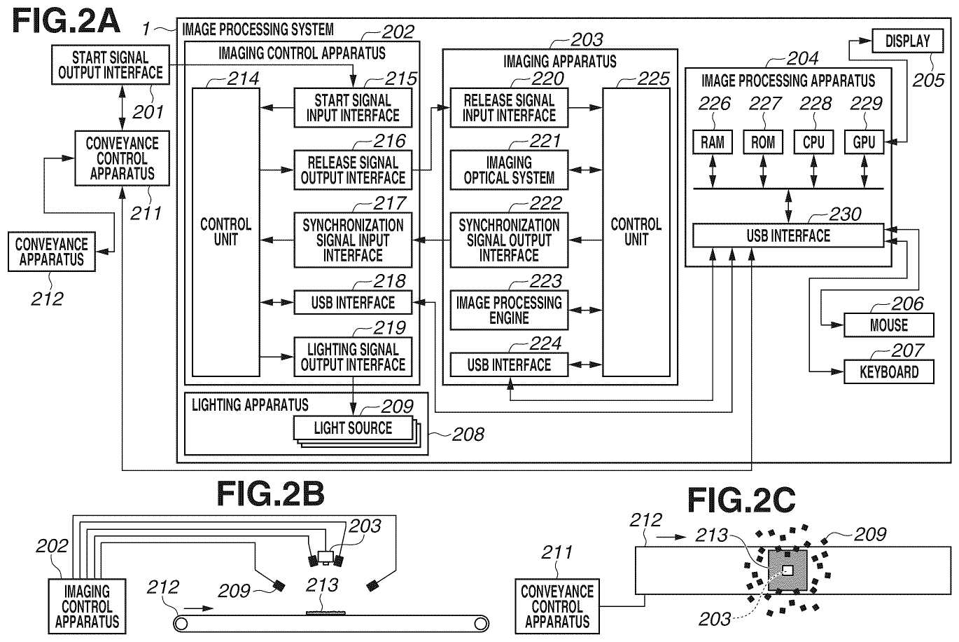

FIG. 2A is a diagram illustrating an example of a hardware configuration of an appearance inspection system in the present embodiment. FIG. 2B is a diagram illustrating an entire external front view of the appearance inspection system, and FIG. 2C is a diagram illustrating an entire external top view of the appearance inspection system. The appearance inspection system in the present embodiment includes an image processing system 1, a start signal output interface 201, a conveyance control apparatus 211, and a conveyance apparatus 212.

The image processing system 1 includes an imaging control apparatus 202, an imaging apparatus 203, an image processing apparatus 204, a display 205, a mouse 206, a keyboard 207, and a lighting apparatus 208. The image processing system 1 is connected to the conveyance control apparatus 211 that controls the conveyance apparatus 212. The conveyance control apparatus 211 conveys an object 213 to be inspected to the image processing system 1 by using the conveyance apparatus 212 and sends an inspection start signal to the image processing system 1 via the start signal output interface 201.

The imaging control apparatus 202 includes a control unit 214 and controls the imaging apparatus 203 and the lighting apparatus 208 to capture an image of the object 213 in synchronization with lighting of a light source. Specifically, in response to the imaging control apparatus 202 receiving an inspection start signal from a start signal input interface 215, the imaging control apparatus 202 sends an image capturing instruction to the imaging apparatus 203 via a release signal output interface 216. The imaging control apparatus 202 receives, from the imaging apparatus 203 via a synchronization signal input interface 217, a synchronization signal that is transmitted to notify an external strobe light source of a lighting timing in synchronization with image capturing. Further, the imaging control apparatus 202 turns on light sources 209 of the lighting apparatus 208 in a predetermined order and combination via a lighting signal output interface 219 in accordance with the received synchronization signal. By the above described operation, images of the object 213 irradiated with light from predetermined light sources 209 are captured. The imaging control apparatus 202 is connected to the image processing apparatus 204 via a universal serial bus (USB) interface 218, receives a command from the image processing apparatus 204, and provides information indicating a state of the imaging control apparatus 202 to the image processing apparatus 204.

The imaging apparatus 203 includes a control unit 225 and an imaging optical system 221 including a lens, an imaging element, and the like. The imaging apparatus 203 generates a captured image by quantization that is performed by an image processing engine 223 on an optical image acquired by image capturing based on an image capturing instruction received via a release signal input interface 220. The imaging apparatus 203 transfers the generated captured image to the image processing apparatus 204 via a USB interface 224. While the present embodiment describes an example in which a still image captured using a digital camera is acquired and used, a predetermined frame may be extracted as a still image from a moving image captured using a video camera and used.

The imaging apparatus 203 sends a synchronization signal to the imaging control apparatus 202 via a synchronization signal output interface 222.

The image processing apparatus 204 includes a random-access memory (RAM) 226, a read-only memory (ROM) 227, a central processing unit (CPU) 228, a graphics processing unit (GPU) 229, and a USB interface 230. These components are connected to each other via an internal bus. Processing illustrated in a flowchart described below is stored in the ROM 227 as a program code.

The program code is loaded into the RAM 226 and executed by the CPU 228 and the GPU 229.

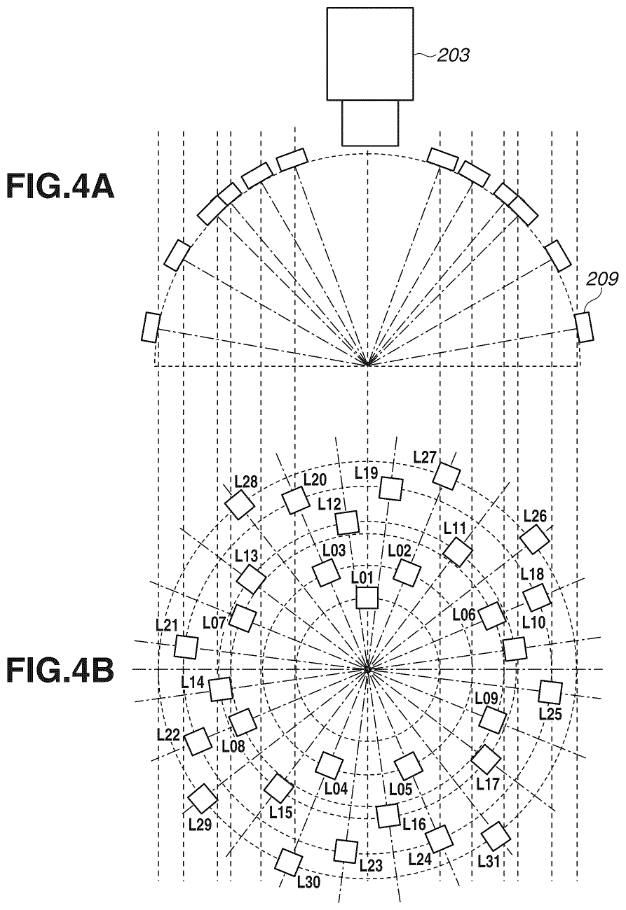

The lighting apparatus 208 includes the plurality of light sources 209. Each of the light sources 209 in the present embodiment is a light emitting diode (LED), but may be a different light source, such as a xenon lamp. FIG. 4 is a diagram illustrating an example of an arrangement of the plurality of light sources 209. FIG. 4A is a front view of the lighting apparatus 208, and FIG. 4B is a top view of the lighting apparatus 208. The light sources 209 indicated by squares are disposed above the object 213 in a hemispherical distribution, and at least one of the zenith angle and the azimuth angle differs among the light sources 209. In FIGS. 4A and 4B, reference numerals L01 to L31 indicate light-source IDs (identification information) for identification of the respective light sources 209. The number and arrangement of the light sources 209 are not limited to the above-described example as long as a plurality of light sources each having a zenith angle and an azimuth angle that are different from those of the other light sources is disposed. The lighting apparatus 208 turns on a predetermined light source 209 among the light sources 209 for a preset time in response to a command from the control unit 214.

While, in the image processing system 1 according to the present embodiment, the imaging control apparatus 202, the imaging apparatus 203, the image processing apparatus 204, and the lighting apparatus 208 are separate apparatuses, these apparatuses may be integrated into one apparatus.

### <Processing To Be Performed by Image Processing System>

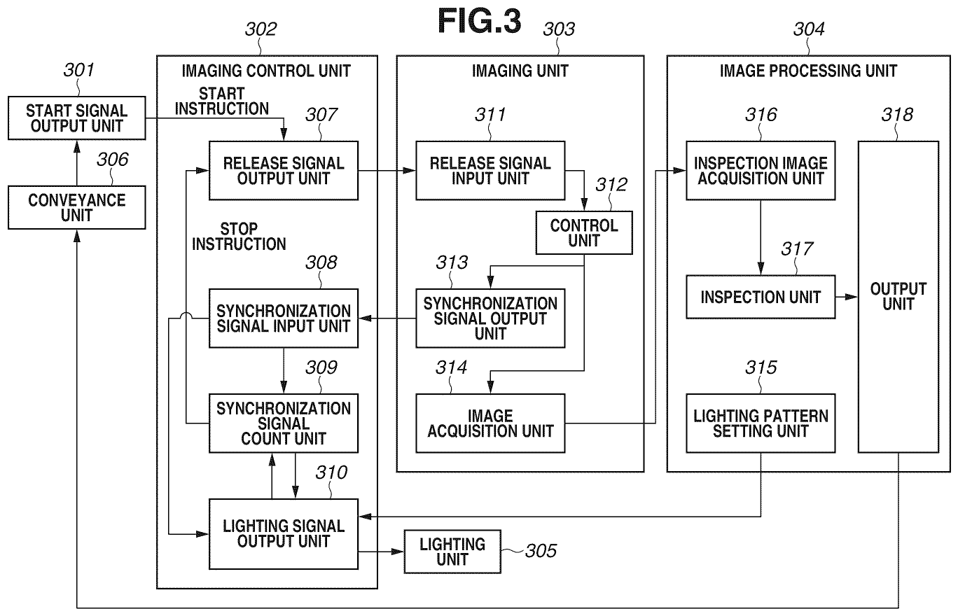

FIG. 3 is a diagram illustrating an example of a functional configuration of the appearance inspection system in the present embodiment. The control unit 214 of the imaging control apparatus 202 includes an imaging control unit 302. The imaging control unit 302 includes a release signal output unit 307, a synchronization signal input unit 308, a synchronization signal count unit 309, and a lighting signal output unit 310. The control unit 225 of the imaging apparatus 203 includes an imaging unit 303. The imaging unit 303 includes a release signal input unit 311, a control unit 312, a synchronization signal output unit 313, and an image acquisition unit 314. The image processing apparatus 204 includes an image processing unit 304. The image processing unit 304 includes a lighting pattern setting unit 315, an inspection image acquisition unit 316, an inspection unit 317, and an output unit 318. The conveyance control apparatus 211 includes a start signal output unit 301. The conveyance apparatus 212 includes a conveyance unit 306. The lighting apparatus 208 includes a lighting unit 305.

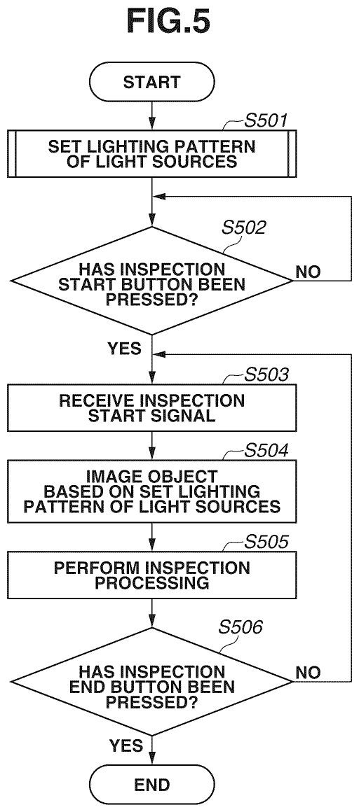

FIG. 5 is a flowchart illustrating processing that is performed by the image processing system 1 in the present embodiment. When the object 213 is conveyed to a predetermined position by the conveyance apparatus 212, the start signal output unit 301 of the conveyance control apparatus 211 sends an inspection start signal to the imaging control unit 302. The processing illustrated in FIG. 5 is started in response to the imaging control unit 302 receiving the inspection start signal.

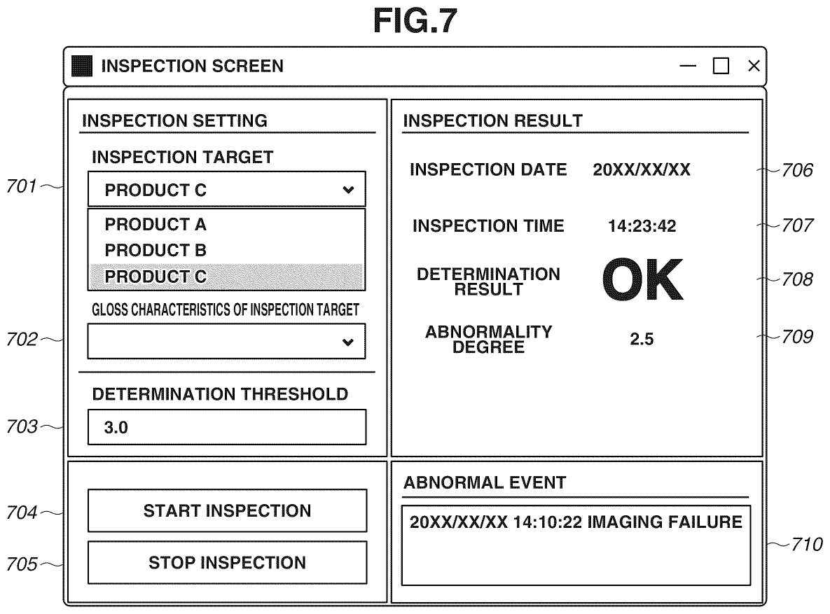

In step S501, the lighting pattern setting unit 315 sets a lighting pattern of the light sources 209. FIG. 7 is a diagram illustrating a user interface (UI) for an inspection. In a selection field 701 of the UI illustrated in FIG. 7, a user can select an inspection target object from a plurality of types of objects registered in advance. In a selection field 702, the user can select a gloss characteristic of the inspection target object from a plurality of types of gloss characteristics registered in advance. The user can perform a selection on either the selection field 701 or the selection field 702. The lighting pattern setting unit 315 sets a lighting pattern of the light sources 209 based on the inspection target object selected by the user in the selection field 701 or the gloss characteristic selected by the user in the selection field 702. The plurality of types of objects registered in advance in the present embodiment is three types: “PRODUCT A”, “PRODUCT B”, and “PRODUCT C”. Further, in the present embodiment, the plurality of types of gloss characteristics registered in advance is three types: “high reflection intensity”, “medium reflection intensity”, and “low reflection intensity”. The UI illustrated in FIG. 7 has a display field 706 for display of an inspection date and a display field 707 for display of an inspection time.

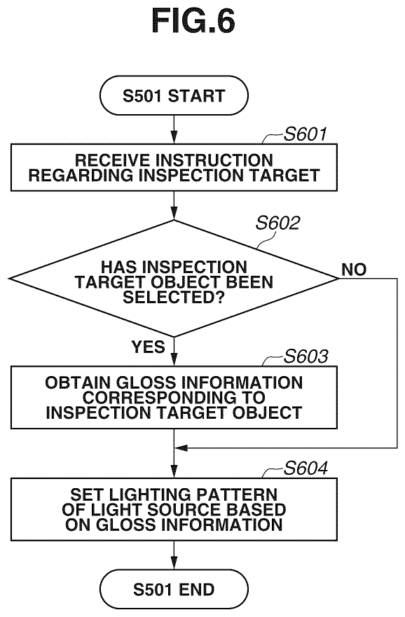

FIG. 6 is a flowchart illustrating details of setting processing of a lighting pattern of the light sources 209 in step S501. In step S601, the lighting pattern setting unit 315 receives an instruction regarding an inspection target from the user. In this processing, the instruction regarding the inspection target from the user is a selection of an inspection target object in the selection field 701 or a selection of the gloss characteristic in the selection field 702.

In step S602, the lighting pattern setting unit 315 determines whether an inspection target object has been selected in the selection field 701. In a case where the inspection target object has been selected (YES in step S602), the processing proceeds to step S603. In step S603, the lighting pattern setting unit 315 acquires gloss information indicating the gloss characteristic corresponding to the selected object.

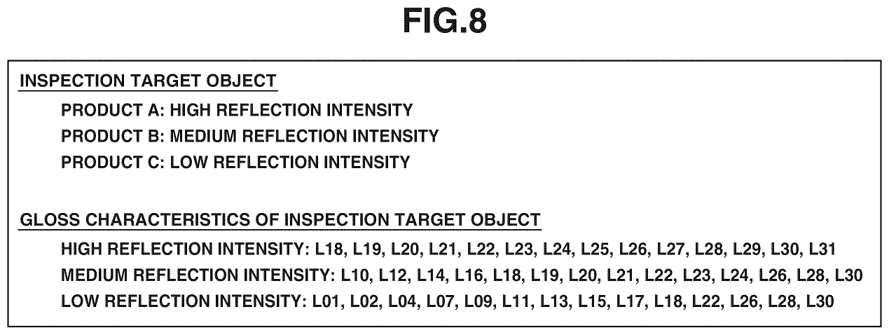

FIG. 8 is a diagram illustrating a list file describing a correspondence relationship between an inspection target object and gloss information, and a correspondence relationship between the gloss information and light source IDs. As illustrated in FIG. 8, in a case where the object selected by the user in the selection field 701 is “PRODUCT A”, the selected object is identified as an object having “high reflection intensity”. In a case where the object selected by the user in the selection field 701 is “PRODUCT B”, the selected object is identified as an object having “medium reflection intensity”. In a case where the object selected by the user in the selection field 701 is “PRODUCT C”, the selected object is identified as an object having “low reflection intensity”. The lighting pattern setting unit 315 acquires gloss information based on the selected object and the above-described correspondence relationship.

In a case where the inspection target object has not been selected in step S602 (NO in step S602), that is, in a case where the gloss characteristic of the inspection target object has been selected, the gloss information has been acquired, and thus the processing proceeds to step S604. In step S604, the lighting pattern setting unit 315 sets a lighting pattern of the light sources 209 based on the gloss information acquired in step S602 or step S603. More specifically, the lighting pattern setting unit 315 sets the light sources 209 having the IDs corresponding to the gloss information acquired in step S602 or step S603 as the lighting light sources, based on the correspondence relationship between the gloss information and the light sources IDs in the list illustrated in FIG. 8. The light source IDs correspond to the arrangement of the light sources 209 illustrated in FIGS. 4A and 4B. The list illustrated in FIG. 8 indicates that with increase in the gloss reflection intensity, a light source group having a relatively large zenith angle is used, and with decrease in the gloss reflection intensity, a light source group having high dispersibility including light sources having a relatively small zenith angle is used.

In step S502, the start signal output unit 301 determines whether an inspection start button 704 in the UI illustrated in FIG. 7 has been pressed by the user. In a case where the start signal output unit 301 determines that the inspection start button 704 has been pressed (YES in step S502), the processing proceeds to step S503. In a case where the start signal output unit 301 determines that the inspection start button 704 has not been pressed (NO in step S502), the processing returns to step S502. In response to the inspection start button 704 being pressed, the conveyance unit 306 conveys the inspection target object to the predetermined position to start the inspection. When the inspection target object is conveyed to the predetermined position, the start signal output unit 301 sends an inspection start signal to the imaging control unit 302. In step S503, the release signal output unit 307 receives the inspection start signal from the start signal output unit 301.

In step S504, the imaging control unit 302 captures images of the inspection target object while sequentially turning on the light sources 209 based on the lighting pattern of the light sources 209 set in step S501. Specifically, in response to the release signal output unit 307 receiving the inspection start signal, the release signal output unit 307 transmits a release ON signal to the release signal input unit 311, and the control unit 312 performs an image capturing operation based on the release ON signal. In the present embodiment, high-speed continuous imaging is performed using a known continuous imaging function. The continuous imaging function is a function of repeating image capturing at a predetermined speed while a release signal is continuously sent, and in the present embodiment, the image capturing is performed at 30 frames per second. The control unit 312 causes the synchronization signal output unit 313 to output a synchronization signal in synchronization with opening of a shutter curtain, to notify the external strobe light source of a light emission timing. When the synchronization signal input unit 308 receives the synchronization signal, the synchronization signal count unit 309 counts the number of receipt times of the synchronization signal, that is, the number of captured images. When the synchronization signal input unit 308 receives the synchronization signal, the lighting signal output unit 310 sends a lighting signal to switch the light sources 209 to be sequentially turned on to the lighting unit 305 in accordance with a lighting pattern of the light sources 209 set by the lighting pattern setting unit 315. The lighting unit 305 turns on the light sources 209 based on the lighting signal. The lighting signal output unit 310 transmits the number of turned-on times of the light sources 209, that is, the total number of captured images to the synchronization signal count unit 309, based on the lighting pattern of the light sources 209. When the number of receipt times of the synchronization signal reaches the total number of captured images, the synchronization signal count unit 309 transmits a stop signal to the release signal output unit 307. In response to receipt of the stop signal, the release signal output unit 307 transmits a release OFF signal to the release signal input unit 311, and the control unit 312 stops image capturing. By the above-described processing, the light sources 209 are turned on for the number of images to be captured set in advance for each inspection target object. The image acquisition unit 314 transfers the plurality of images captured by turning on the predetermined light sources 209 and imaging the object to the image processing unit 304 at any timing as needed.

In step S505, the image processing unit 304 performs inspection processing based on the captured images. The inspection image acquisition unit 316 receives the captured images from the image acquisition unit 314. The inspection unit 317 detects a defect by spatial filter processing using a plurality of captured images corresponding to light irradiation from a plurality of directions. Examples of a target of the spatial filter processing includes captured images themselves, and a normal image (shape image) and a reflectance image (color image) which have been acquired by combining a plurality of captured images by the photometric stereo method. A reaction value to the spatial filter processing is integrated and digitized, and a result of the processing is displayed as an abnormality degree in an abnormality degree display 709 illustrated in FIG. 7. The inspection unit 317 compares a determination threshold value set in a threshold value setting field 703 illustrated in FIG. 7 with the abnormality degree, whereby determination of whether the inspection is passed or failed is performed.

The threshold value setting field 703 is a text box, and the user can set a determination threshold value. The output unit 318 displays OK (pass) or NG (fail) in a result display field 708 illustrated in FIG. 7 as a result of the inspection. When an abnormal event occurs, details of the abnormal event are displayed in a display field 710. The output unit 318 notifies the conveyance unit 306 of inspection result information indicating OK or NG. The conveyance unit 306 performs predetermined processing, such as discharging an object determined as NG outside the system, based on the inspection result information. While inspection items in the present embodiment are color and shape, the inspection items are not limited to these. The inspection items may be any item that represents an appearance and can be imaged and used for determination, and may be, for example, a material or a pattern.

At step S506, the start signal output unit 301 determines whether an inspection stop button 705 in the UI illustrated FIG. 7 has been pressed by the user. In a case where the start signal output unit 301 determines that the inspection stop button 705 has not been pressed (NO in step S506), the processing returns to step S503. In a case where the start signal output unit 301 determines that the inspection stop button 705 has been pressed (YES in step S506), the series of inspection operations ends.

As described above, the image processing system 1 sets light sources 209 to be turned on from among the plurality of light sources 209 disposed at different positions from each other, based on the gloss reflection intensity of an inspection target object. The inspection processing is performed on the object based on a plurality of images acquired by image capturing the object irradiated with light by the set light sources 209. With this configuration, accuracy of the inspection of an object surface based on captured images is improved. In particular, as for an object having a high gloss reflection intensity, the light sources 209 having a relatively small zenith angle are used to prevent the object from being significantly affected by the surface reflection component. As for an object with a low gloss reflection intensity, both the light sources 209 having a small zenith angle and the light sources 209 having a large zenith angle are widely used to improve accuracy of deriving shape information and a reflectance. By controlling lighting of the light sources 209 in this manner, an appearance inspection using a lighting pattern appropriate to gloss characteristics of an object can be performed.

When the inspection target object is larger than a predetermined size or when a plurality of inspection target objects is inspected at the same time, there arises an issue that an influence of gloss characteristics lowers inspection accuracy, but the embodiment described above can be applied even under these conditions.

When an inspection is performed on an inspection target object smaller than a predetermined size, the issue that an influence of gloss characteristics lowers inspection accuracy is less likely to occur. Thus, based on object information, such as the size and the number of inspection target objects, it may be possible to switch between an inspection mode in which a lighting pattern is set based on the gloss reflection intensity of the object, as in the present embodiment, and an inspection mode in which a fixed lighting pattern is used.

The object information may be input by the user via an UI, or the size and the number of objects may be determined using an image acquired by the imaging apparatus 203 performing image capturing. Inspection mode switching may be automatically performed based on determination of whether the size or the number of the inspection target objects is larger than a predetermined threshold. Alternatively, the user may select an inspection mode via the UI. To improve inspection accuracy, the fixed lighting pattern may be configured as a lighting pattern in which both the light sources 209 having a small zenith angle and the light sources 209 having a large zenith angle are widely used.

While the present embodiment is configured such that either the selection field 701 or the selection field 702 can be designated, either the selection field 701 or the selection field 702 may be omitted from the UI illustrated in FIG. 7.

According to the present disclosure, accuracy of inspection of an object surface based on captured images can be improved.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-157661, which was filed on Sep. 11, 2024 and which is hereby incorporated by reference herein in its entirety.

What is claimed is:

1. An image processing apparatus comprising:
at least one processor; and
at least one memory that is in communication with the at least one processor, wherein the at least one memory stores instructions for causing the at least one processor and the at least one memory to:
set a light source to be turned on from among a plurality of light sources disposed at positions different from each other, based on a gloss reflection intensity of an object to be inspected; and
perform inspection processing on the object, based on a plurality of images of the object, wherein, in the plurality of images of the object, the object is irradiated with light from the set light source.

2. The image processing apparatus according to claim 1, wherein the plurality of light sources differs from each other in at least one of a zenith angle and an azimuth angle.

3. The image processing apparatus according to claim 1, wherein the at least one memory further stores instructions for causing the at least one processor and the at least one memory to, in a case where the object has a first gloss reflection intensity, set an increased number of the light sources having a small zenith angle to be turned on in comparison with a case in which the object has a second gloss reflection intensity higher than the first gloss reflection intensity.

4. The image processing apparatus according to claim 1, wherein the at least one memory further stores instructions for causing the at least one processor and the at least one memory to set the light source to be turned on based on a gloss reflection intensity designated by a user via a user interface.

5. The image processing apparatus according to claim 1, wherein the at least one memory further stores instructions for causing the at least one processor and the at least one memory to set the light source to be turned on based on an object type designated by a user via a user interface.

6. The image processing apparatus according to claim 1, wherein the at least one memory further stores instructions for causing the at least one processor and the at least one memory to set the light source to be turned on based on a correspondence relationship between the gloss reflection intensity and identification information on the plurality of light sources.

7. The image processing apparatus according to claim 1, wherein the at least one memory further stores instructions for causing the at least one processor and the at least one memory to perform control to synchronize a lighting timing of the light source with an imaging timing.

8. The image processing apparatus according to claim 1, wherein the inspection processing is to inspect at least one of a shape and a color of a surface of the object.

9. The image processing apparatus according to claim 1, wherein the at least one memory further stores instructions for causing the at least one processor and the at least one memory to perform the inspection processing by combining the plurality of images by a photometric stereo method.

10. The image processing apparatus according to claim 1, wherein the at least one memory further stores instructions for causing the at least one processor and the at least one memory to perform switching between a first mode in which the set light source is turned on and a second mode in which a predetermined light source is turned on, based on information on the object.

11. An image processing method comprising:
setting a light source to be turned on from among a plurality of light sources disposed at positions different from each other, based on a gloss reflection intensity of an object to be inspected; and
performing inspection processing on the object, based on a plurality of images of the object, wherein, in the plurality of images of the object, the object is irradiated with light from the set light source.

12. A non-transitory computer-readable storage medium storing instructions that, when executed by a computer, cause the computer to perform an image processing method, the image processing method comprising:
setting a light source to be turned on from among a plurality of light sources disposed at positions different from each other, based on a gloss reflection intensity of an object to be inspected;
performing inspection processing on the object, based on a plurality of images of the object, wherein, in the plurality of images of the object, the object is irradiated with light from the set light source.
